(19) United States
(12) Patent Application Publication
(10) Pub. No.: US 2026/0253807 A1
(43) Pub. Date: Aug. 27, 2026

(54) MULTILAYER CERAMIC ELECTRONIC DEVICE AND MANUFACTURING METHOD OF THE SAME

(71) Applicant: TAIYO YUDEN CO., LTD., Tokyo (JP)

(72) Inventor: Koichiro MORITA, Tokyo (JP)

(73) Assignee: TAIYO YUDEN CO., LTD., Tokyo (JP)

(21) Appl. No.: 19/459,227

(22) Filed: Jan. 26, 2026

(30) Foreign Application Priority Data
Feb. 27, 2025 (JP) 2025-030323

(51) Int. Cl. H01G 4/30; H01G 4/008; H01G 4/012; H01G 4/12

(52) U.S. Cl. CPC H01G 4/30; H01G 4/0085; H01G 4/012; H01G 4/1227

(57) ABSTRACT

A multilayer ceramic electronic device includes a plurality of internal electrode layers facing each other, containing nickel as a main component, containing magnesium oxide inside thereof, having a thickness of 0.8 μm or less and a continuity modulus of 90% or more, a dielectric layer sandwiched by the plurality of internal electrode layers, and external electrodes electrically connected to the plurality of internal electrode layers respectively.

### CROSS-REFERENCE TO RELATED APPLICATION

This application is based upon and claims the benefit of priority of the prior Japanese Patent Application No. 2025-030323, filed on Feb. 27, 2025, the entire contents of which are incorporated herein by reference.

### FIELD

A certain aspect of the present disclosure relates to a multilayer ceramic electronic device and a manufacturing method of the multilayer ceramic electronic device.

### BACKGROUND

Multilayer ceramic electronic devices such as multilayer ceramic capacitors (MLCCs), which use base metals such as nickel and copper in the internal electrode layers (see, for example, Japanese Patent Application Publication No. 2011-091083 and Japanese Patent Application Publication No. 2011-139028), are incorporated into a wide variety of electronic circuits, from smartphones to electric vehicles.

### SUMMARY OF THE INVENTION

According to an aspect of the embodiments, there is provided a multilayer ceramic electronic device including: a plurality of internal electrode layers facing each other, containing nickel as a main component, containing magnesium oxide inside thereof, having a thickness of 0.8 μm or less and a continuity modulus of 90% or more; a dielectric layer sandwiched by the plurality of internal electrode layers; and external electrodes electrically connected to the plurality of internal electrode layers respectively.

According to another aspect of the embodiments, there is provided a manufacturing method as a multilayer ceramic electronic device including: forming each of internal electrode patterns on each of ceramic green sheets using conductive paste containing magnesium and nickel; forming a multilayer body by stacking the ceramic green sheets; firing the multilayer body under a first oxygen partial pressure and a first temperature to form a Ni—Mg—O composite oxide in each of the internal electrode patterns; firing the multilayer body under a second oxygen partial pressure and a second temperature higher than the first temperature, and forming the ceramic green sheets into dielectric layers; firing the multilayer body under a third oxygen partial pressure lower than the first oxygen partial pressure and the second oxygen partial pressure and a third temperature lower than the second temperature, and forming internal electrode layers containing magnesium therein from the internal electrode patterns; and forming an external electrode on the multilayer body.

### BRIEF DESCRIPTION OF THE DRAWINGS

FIG. 1 illustrates a sintering start temperature;

FIG. 2 is a partial cross-sectional perspective view of a multilayer ceramic capacitor;

FIG. 3 is a cross-sectional view taken along line A-A in FIG. 2;

FIG. 4 is a cross-sectional view taken along line B-B in FIG. 2;

FIG. 5A and FIG. 5B are enlarged cross-sectional views of vicinity of an external electrode;

FIG. 6 is a schematic cross-sectional view of a dielectric layer;

FIG. 7 is a schematic cross-sectional view of an internal electrode layer;

FIG. 8 is a schematic cross-sectional view illustrating a portion of a multilayer structure of dielectric layers and internal electrode layers;

FIG. 9 is a diagram illustrating a continuity modulus of an internal electrode layer;

FIG. 10 illustrates a manufacturing method of a multilayer ceramic capacitor;

FIG. 11A and FIG. 11B illustrate a forming process of an internal electrode;

FIG. 12 illustrates a pressing process;

FIG. 13A to FIG. 13D illustrate a firing process;

FIG. 14A to FIG. 14C illustrate a capacitance density increase ratio; and

FIG. 15 illustrates Example and Comparative Example.

### DETAILED DESCRIPTION

In particular, in recent years, there has been a demand for small or thin, high-capacity multilayer ceramic electronic devices in compact, high-performance electronic devices.

Therefore, the challenge for multilayer ceramic electronic devices is how to increase capacitance density, which is the electrostatic capacity per volume.

To solve this problem, it is common to thin the dielectric layers, thereby increasing the number of layers and increasing the dielectric constant. However, thinning the dielectric layer means an increase in the electric field strength, which makes it difficult to ensure reliability, and an increase in the dielectric constant also has the theoretical disadvantage of increasing the rate of capacitance loss when a DC voltage is applied.

One of the best ways to increase capacitance density without these disadvantages is to thin the internal electrode layers and increase the number of layers accordingly. However, this method poses challenges for implementation. If the internal electrode layer thickness is up to around 1.0 μm, simply printing the internal electrode layer thinly is sufficient. However, attempting to make it thinner than this makes it difficult to print it smoothly. Even if it is possible to print it smoothly, the internal electrode layer may become discontinuous or island-like during the sintering process, reducing the effective electrode area. Island-like internal electrode layers may become spherical due to surface energy and protrude toward the dielectric layer, reducing the effective dielectric thickness and resulting in reduced reliability. For this reason, there has been a demand for technology that can thin the internal electrode layer to 1.0 μm or less while maintaining continuity.

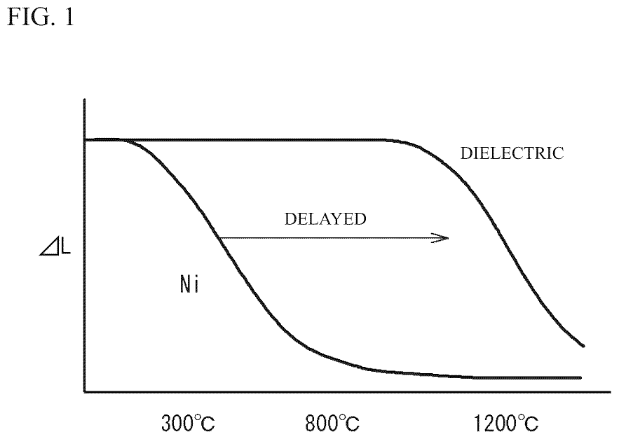

FIG. 1 illustrates the sintering start temperature. In FIG. 1, the vertical axis represents the amount of shrinkage, with smaller values indicating greater shrinkage. As illustrated in FIG. 1, during the heating process, the nickel contracts before the dielectric. While the sintering start temperature for nickel powder is approximately 700° C., the sintering start temperature for dielectrics is typically higher, at 1100° C. or higher. Therefore, when fired to the dielectric sintering temperature, the internal electrode layers become oversintered, resulting in discontinuities, islanding, and spherical formation. While discontinuities are less likely when the internal electrode layers are printed thickly, the difference in sintering start temperatures makes them more susceptible to breakage when printed thinly. For this reason, a known method for thinning the internal electrode layers to 1.0 μm or less involves mixing small ceramic particles (several tens to hundreds of nanometers) into the nickel paste to inhibit and delay the sintering of the nickel powder particles. These small ceramic particles are called “co-materials.” The composition of the co-material is often the same as that of the dielectric layer, or has the same main components, but is smaller in diameter than the raw material for the dielectric layer. This co-material allows the sintering start temperature of the nickel paste to be closer to that of the dielectric, thereby suppressing discontinuities.

However, this method using a co-material also has its limitations. For example, if the internal electrode layer becomes thin (0.8 μm or lrss) after sintering, the co-material kneaded into the nickel paste may be expelled from the nickel powder and agglomerate, acting as a starting point for discontinuing the internal electrode layer. This can easily lead to discontinuities in the internal electrode layer when applied in small amounts. On the other hand, without the use of a co-material, discontinuities would occur due to the difference in sintering start temperatures, as mentioned above. Therefore, it has been difficult to form highly continuous internal electrode layers of 0.8 μm or less.

Instead of printing nickel paste, methods have also been proposed for forming internal electrode layers directly on ceramic green sheets using sputtering or plating. While these techniques can indeed form internal electrode layers of 0.8 μm or less in thickness and achieve 100% continuity modulus before sintering, these internal electrode layers do not sinter and do not shrink. Therefore, when the dielectric layer shrinks during sintering, a shrinkage mismatch may cause cracks at the interface between the internal electrode layer and the dielectric layer.

As a result, none of the above methods have been able to form highly continuous internal electrode layers of 0.8 μm or less after sintering. In light of this situation, a method of layering flat nickel powder has been proposed as a method for printing nickel paste to fabricate multilayer ceramic capacitors with thin internal electrode layers of 0.8 μm or less (see, for example, Japanese Patent Application Publication No. 2011-091083). However, this technology has the problem of easily causing interlayer delamination due to gaps forming within the internal electrode layer and at the interface with the dielectric layer. Furthermore, there are problems with reliability, such as a high electric field at the tips of flake pieces protruding toward the dielectric layer, which reduces reliability, resulting in insufficient reliability.

Hereinafter, an exemplary embodiment will be described with reference to the accompanying drawings.

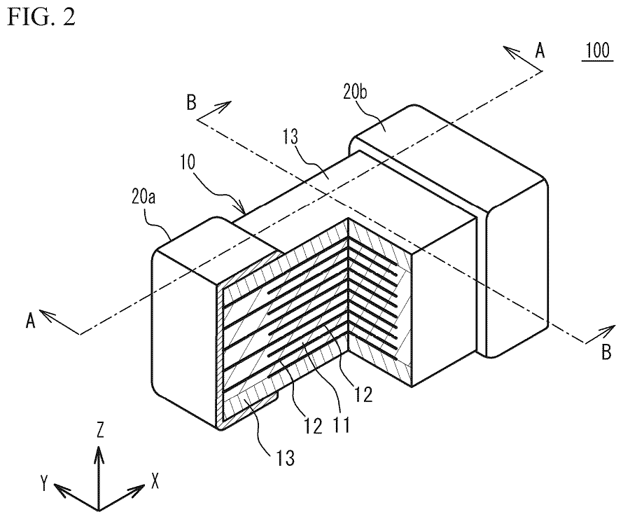

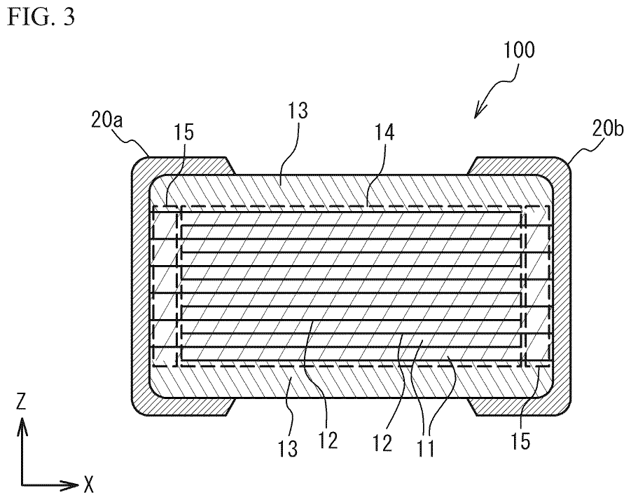

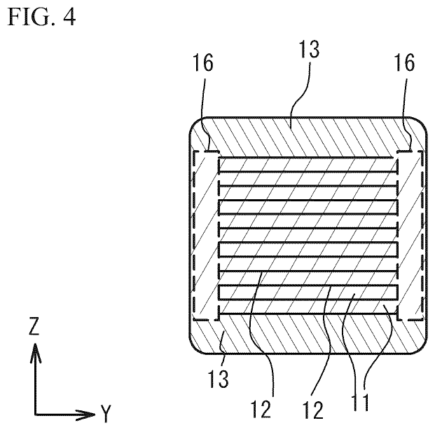

(Embodiment) FIG. 2 illustrates a perspective view of a multilayer ceramic capacitor 100, in which a cross section of a part of the multilayer ceramic capacitor 100 is illustrated. FIG. 3 is a cross-sectional view taken along line A-A in FIG. 2. FIG. 4 is a cross-sectional view taken along line B-B in FIG. 2. As illustrated in FIG. 2 to FIG. 4, the multilayer ceramic capacitor 100 includes an element body 10 having a rectangular parallelepiped shape, and external electrodes 20a and 20b that are respectively provided on two end faces of the element body 10 facing each other. Among four faces other than the two end faces of the element body 10, two faces other than the upper face and the lower face in the stacking direction are referred to as side faces. Each of the external electrodes 20a and 20b extends to the upper face and the lower face in the stacking direction and the two side faces of the element body 10. However, the external electrodes 20a and 20b are spaced from each other.

In FIG. 2 to FIG. 4, the Z-axis direction (first direction) is the stacking direction, and is the direction in which the internal electrode layers face each other. The X-axis direction (second direction) is the length direction of the element body 10, and is the direction in which the two end faces of the element body 10 face each other, and in which the external electrodes 20a and 20b face each other. The Y-axis direction (third direction) is the width direction of the internal electrode layers, and is the direction in which the two side faces other than the two end faces of the four side faces of the element body 10 face each other. The X-axis direction, Y-axis direction, and Z-axis direction are orthogonal to each other.

The element body 10 has a structure designed to have dielectric layers 11 (dielectric ceramic composition) and internal electrode layers 12 alternately stacked. The dielectric layer 11 contains a ceramic material acting as a dielectric material. End edges of the internal electrode layers 12 are alternately exposed to a first end face of the element body 10 and a second end face of the element body 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIGS. 2 to 4, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

A main component of the internal electrode layers 12 is nickel (Ni). For example, the internal electrode layers 12 contain 90 at % or more of nickel. The thickness of each of the internal electrode layers 12 in the Z-axis direction is 0.8 μm or less, or 0.5 μm or less, or 0.3 μm or less. The thickness of each of the internal electrode layers 12 in the Z-axis direction is, for example, 0.1 μm or more. The thickness of each of the internal electrode layers 12 can be obtained by observing the cross section of the multilayer ceramic capacitor 100 with a scanning electron microscope (SEM), measuring the thickness at 10 points of the internal electrode layer 12, and deriving the average value.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr_{z}O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like. For example, the concentration of the main component ceramic material in the dielectric layer 11 is 90 at % or more. The thickness of each of the dielectric layers 11 in the Z-axis direction is, for example, 0.2 μm or more and 2.0 μm or less, 0.3 μm or more and 1.0 μm or less, or 0.3 μm or more and 0.8 μm or less. The thickness of each of the dielectric layers 11 can be obtained by observing a cross section of the multilayer ceramic capacitor 100 with a scanning electron microscope (SEM), measuring the thickness at 10 points of the dielectric layer 11, and deriving the average value.

Additives may be added to the dielectric layer 11. As additives to the dielectric layer 11, an oxide of zirconium (Zr), hafnium (Hf), magnesium (Mg), manganese (Mn), molybdenum (Mo), vanadium (V), chromium (Cr), a rare earth element (yttrium (Y), samarium (Sm), europium (Eu), gadolinium (Gd), terbium (Tb), dysprosium (Dy), holmium (Ho), erbium (Er), thulium (Tm), or ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 3, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 4, in the element body 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

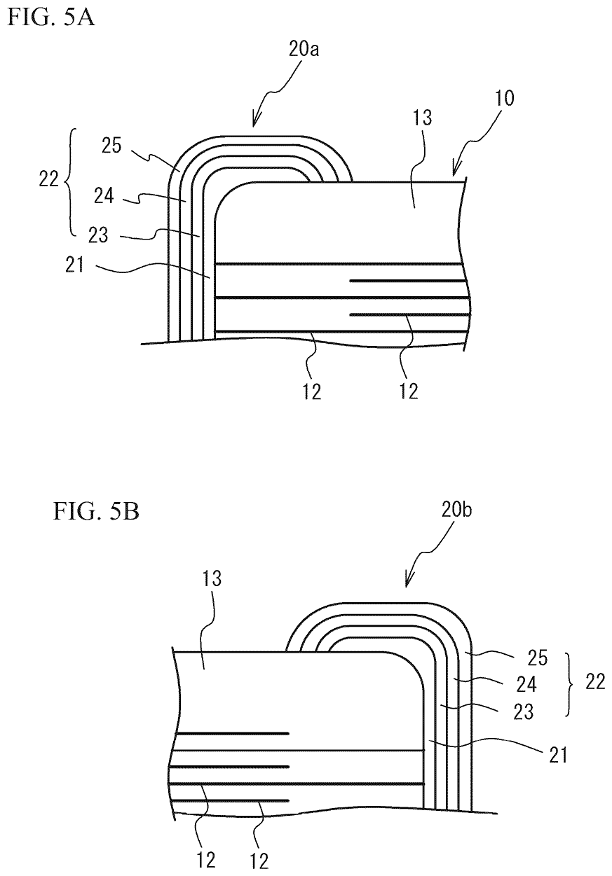

FIG. 5A is an enlarged cross-sectional view of the vicinity of the external electrode 20a. FIG. 5B is an enlarged cross-sectional view of the vicinity of the external electrode 20b. Hatching is omitted in FIG. 5A and FIG. 5B. As illustrated in FIG. 5A and FIG. 5B, the external electrodes 20a, 20b have a structure in which a plated layer 22 is provided on a base layer 21. The base layer 21 is primarily composed of silver, a silver-palladium alloy, platinum, or the like. The base layer 21 may also contain a glass component. The plated layer 22 is primarily composed of a metal such as nickel, copper, aluminum, zinc, or tin, or an alloy of two or more of these metals. The plated layer 22 may be composed of a single metal component, or multiple plated layers composed of different metal components. For example, the plated layer 22 has a structure in which, from the base layer 21 side, a first plated layer 23, a second plated layer 24, and a third plated layer 25 are formed. The first plated layer 23 is, for example, a copper plated layer, the second plated layer 24 is, for example, a nickel plated layer, and the third plated layer 25 is, for example, a tin plated layer.

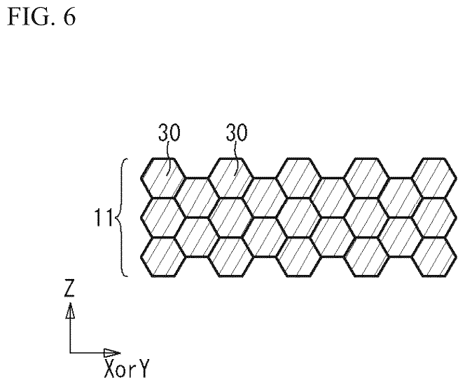

FIG. 6 is a schematic cross-sectional view of the dielectric layer 11. As illustrated in FIG. 6, the dielectric layer 11 has a structure in which a plurality of dielectric grains 30 of the main component ceramic are sintered. For example, the dielectric layer 11 may have the single dielectric grain 30 in the thickness direction (Z-axis direction), or may have a structure in which the plurality of dielectric grains 30 are connected via grain boundaries, as illustrated in FIG. 6. The dielectric grains 30 may be perovskite ceramic grains such as barium titanate, or may be ceramic grains in which other elements are solid-dissolved.

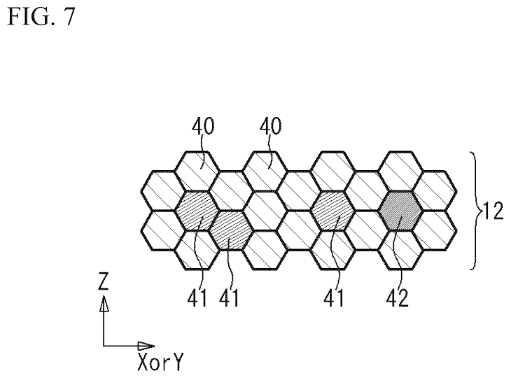

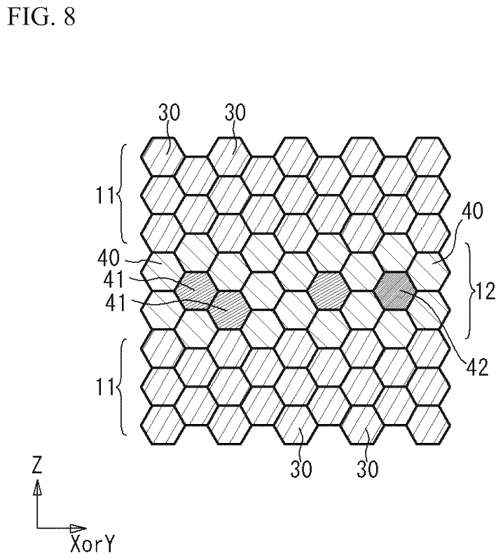

FIG. 7 is a schematic cross-sectional view of the internal electrode layer 12. FIG. 8 is a schematic cross-sectional view illustrating a portion of the multilayer structure of the dielectric layers 11 and the internal electrode layers 12. As illustrated in FIG. 7 and FIG. 8, the internal electrode layer 12 has a structure in which a plurality of nickel grains 40, the main component, are sintered. For example, the internal electrode layer 12 may have the single nickel grain 40 in the thickness direction, or may have a structure in which the plurality of nickel grains 40 are connected via grain boundaries, as illustrated in FIG. 7 and FIG. 8.

Furthermore, in this embodiment, magnesium oxide grains 41 are contained within the internal electrode layer 12. By containing the magnesium oxide grains 41 in the internal electrode layer 12, discontinuities in the internal electrode layer 12 are less likely to occur, even if the internal electrode layer 12 is formed thin. Specifically, even if the internal electrode layer 12 has a thickness of 0.8 μm or less, the continuity modulus of the internal electrode layer 12 can be maintained at 90% or more.

As such, in this embodiment, the internal electrode layers 12 can be thinned to 0.8 μm or less while maintaining a continuity modulus of 90% or more. This allows the number of layers to be increased to increase capacitance density at a rate close to the theoretical value. At this time, deterioration in reliability can be suppressed. For example, with conventional shrinkage control methods using co-materials, discontinuities occur when the internal electrode layers are 0.8 μm or less, resulting in significant capacitance loss. Therefore, increasing the number of layers does not increase capacitance density as expected. In addition, the spheroidized internal electrode layers create thin sections in the dielectric layer, reducing reliability. In contrast, according to this embodiment, the high continuity modulus of the internal electrode layers 12 suppresses spheroidization, thereby suppressing deterioration in reliability.

In addition, this embodiment has secondary effects in addition to increasing capacitance density and reliability. Specifically, it is possible to improve the mechanical properties of the multilayer ceramic capacitor 100. For example, residual magnesium within nickel is not a negative factor, as long as it does not cause discontinuities in the internal electrode layers. This structure increases the rigidity of the electrode layer compared to simple nickel metal layer, making the multilayer ceramic capacitor 100 with the multiple internal electrode layers 12 less susceptible to deformation and cracking due to external stresses such as bending of the mounting substrate. Therefore, this structure is particularly suitable for low-profile, thin multilayer ceramic capacitors, for which ensuring element strength is difficult. In low-profile, thin multilayer ceramic capacitors, the number of layers is significantly limited due to restrictions on the external dimensions and thickness. Therefore, thinning the electrodes significantly improves capacitance. Therefore, low-profile, thin multilayer ceramic capacitors are one of the most suitable products for applying this embodiment, which also features improved mechanical strength. Here, a low-profile, thin multilayer ceramic capacitor is a multilayer ceramic capacitor whose height in the stacking direction is less than half its length in the width direction.

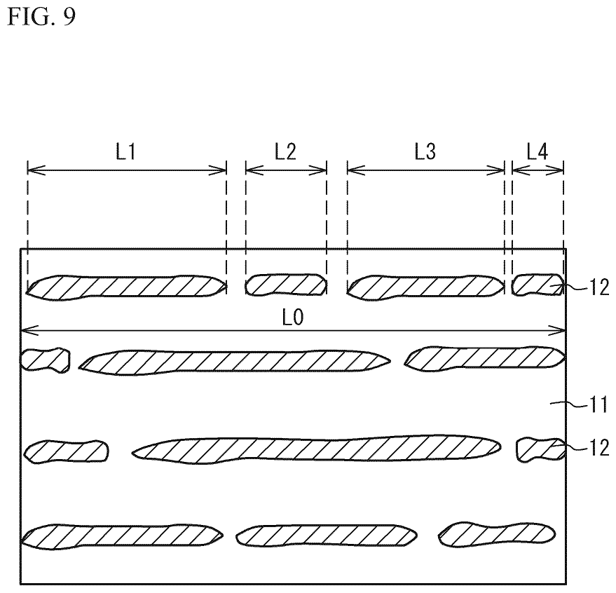

FIG. 9 is a diagram illustrating the continuity modulus of the internal electrode layer 12. As illustrated in FIG. 9, in an observation area of length L0 in the internal electrode layer 12, the lengths L1, L2, . . . , Ln of the metal portions are measured and summed, and the metal portion ratio, ΣLn/L0, can be defined as the continuity modulus of that layer. In this embodiment, the continuity modulus is measured with length L0 set to 25 μm.

For example, in this embodiment, the internal electrode layer 12 can have a continuity modulus of 93% or more, or 95% or more.

Of all the internal electrode layers 12 included in the multilayer ceramic capacitor 100, at least two adjacent layers should contain magnesium oxide, have a thickness of 0.8 μm or less, and have a continuity modulus of 90% or more. Of all the internal electrode layers 12 included in the multilayer ceramic capacitor 100, it is preferable that 50% or more of the internal electrode layers 12 contain magnesium oxide therein, have a thickness of 0.8 μm or less, and have a continuity modulus of 90% or more, and it is preferable that 80% or more of the internal electrode layers 12 contain magnesium oxide therein, have a thickness of 0.8 μm or less, and have a continuity modulus of 90% or more.

The magnesium oxide grains 41 may be in contact with the adjacent dielectric layer 11, but are preferably contained within the internal electrode layers 12. For example, it is preferable that the magnesium oxide grains 41 are not in contact with the adjacent dielectric layers 11. For example, it is preferable that the magnesium oxide grains 41 are surrounded by the plurality of nickel grains 40 and not in contact with the dielectric layers 11.

For example, the magnesium oxide grains 41 may be magnesium oxide or a composite oxide of nickel and magnesium. For example, the magnesium oxide grains 41 may be crystals represented as MgO or Ni—Mg—O.

Furthermore, nickel-magnesium alloy grains 42, which are an alloy of nickel and magnesium, may be contained within the dielectric layers 11. FIG. 7 and FIG. 8 illustrate examples of the nickel-magnesium alloy grains 42. For example, it is preferable that the nickel-magnesium alloy grains 42 are not in contact with the adjacent dielectric layers 11 and are surrounded by the plurality of nickel grains 40. Some of the grains surrounding the nickel-magnesium alloy grains 42 may be the magnesium oxide grains 41.

The composition of each grain contained in the internal electrode layer 12 can be determined using a scanning electron microscope (SEM) equipped with EDS (Energy Dispersive X-ray Spectroscopy).

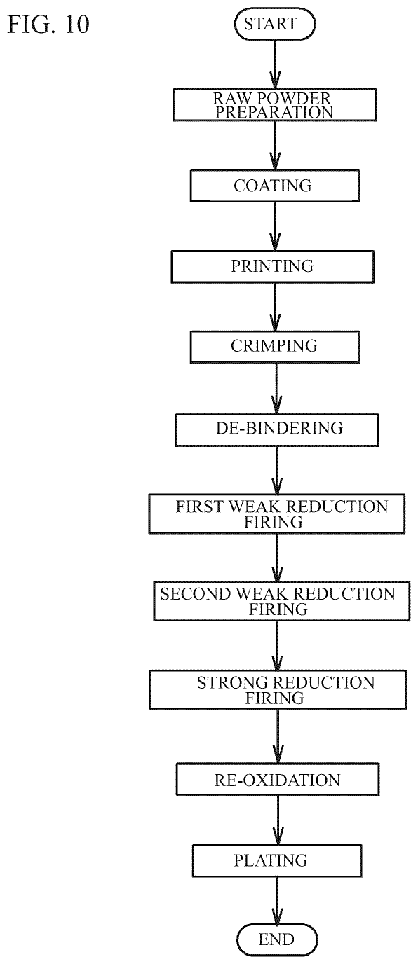

Next, a description will be given of a manufacturing method of the multilayer ceramic capacitors 100. FIG. 10 illustrates a manufacturing method of the multilayer ceramic capacitor 100.

(Raw material powder preparation process) A dielectric material for forming the dielectric layer 11 is prepared. An A site element and a B site element are included in the dielectric layer 11 in a sintered phase of grains of ABO₃. For example, barium titanate is tetragonal compound having a perovskite structure and has a high dielectric constant. This barium titanate can generally be synthesized by reacting a titanium raw material such as titanium dioxide with a barium raw material such as barium carbonate, and a calcium raw material such as calcium carbonate. Various methods have been known for synthesizing barium titanate, which is the main component of the dielectric layer 11, such as the solid phase method, the sol-gel method, and the hydrothermal method. Any of these methods can be used in this embodiment.

Predetermined additives are added to the resulting ceramic powder. For example, an oxide or a glass containing Zr (zirconium), V (vanadium), Cr (chromium), Co (cobalt), Ni (nickel), Li (lithium), B (boron), Na (sodium), or K (potassium) may be used. Furthermore, if necessary, an oxide of a rare earth element such as Gd (gadolinium), Sc (scandium), Y (yttrium), La (lanthanum), Ce (cerium), Pr (praseodymium), Nd (neodymium), Pm (promethium), Sm (samarium), Tb (terbium), Dy (dysprosium), Ho (holmium), Er (erbium), Tm (thulium), Y (ytterbium), or Lu (lutetium) may also be added.

For example, a ceramic material is prepared by wet-mixing a compound containing an additive compound with a ceramic raw material powder, drying and pulverizing the mixture. For example, the ceramic material obtained as described above may be pulverized to adjust the particle size, if necessary, or may be combined with a classification process to adjust the particle size. Through the above steps, a dielectric powder is obtained.

(Coating process) Next, a binder such as polyvinyl butyral (PVB) resin, an organic solvent such as ethanol or toluene, and a plasticizer are added to the obtained dielectric material and wet-mixed. Using the obtained slurry, a ceramic green sheet 51 is formed on the substrate by, for example, a die coater method or a doctor blade method, and dried. The substrate is, for example, polyethylene terephthalate (PET) film. The process is not illustrated.

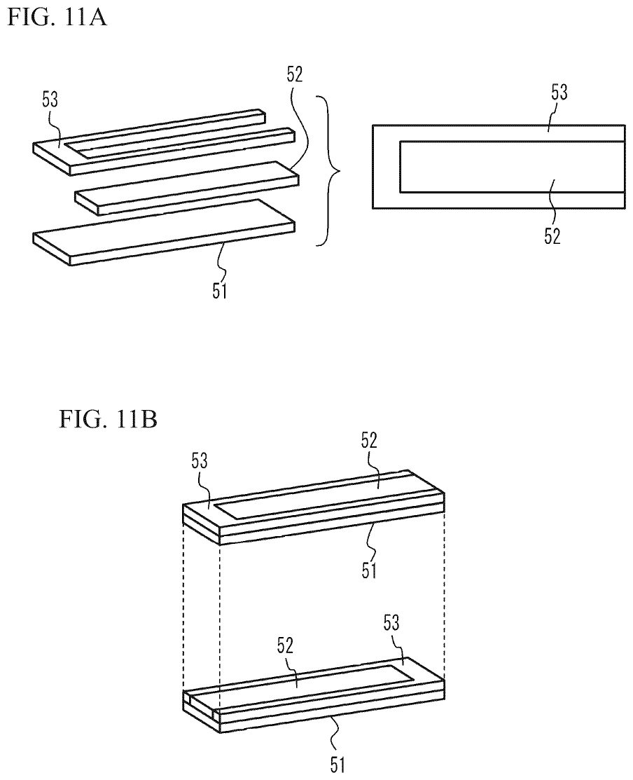

(Printing process) Next, as illustrated in FIG. 11A, a metal conductive paste for forming internal electrodes containing an organic binder is printed on the surface of the ceramic green sheet 51 by screen printing, gravure printing, or the like to form internal electrodes. Thus, an internal electrode pattern 52 for layers is arranged. The conductive paste contains nickel powder and magnesium oxide (MgO) powder.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 11A, a dielectric pattern 53 is formed by printing the resulting slurry in the peripheral region, where the internal electrode pattern 52 is not printed, on the ceramic green sheet 51 to cause the dielectric pattern 53 and the internal electrode pattern 52 to form a flat surface. The ceramic green sheet 51 on which the internal electrode pattern 52 and the dielectric pattern 53 are printed is referred to as a stack unit.

Thereafter, as illustrated in FIG. 11B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 or more and 1000 or less.

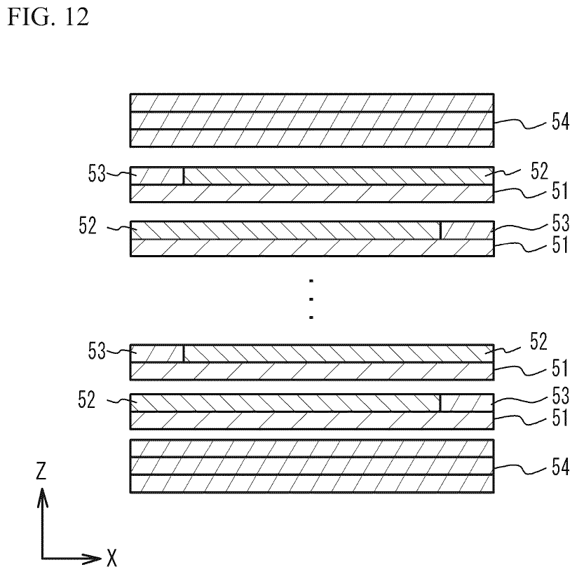

(Pressing process) A predetermined number (for example, 2 to 10) cover sheets are stacked on the stacked stack units and under the stacked stack units as illustrated in FIG. 12. After that, the stacked structure is thermally pressed. The cover sheet is also a green sheet including a ceramic powder. Thereafter, the multilayer body is cut into chips of predetermined dimensions (for example, 1.0 mm×0.5 mm) to obtain a multilayer body.

(De-binding process) Next, the multilayer body is heat-treated in a reducing atmosphere to remove the binder.

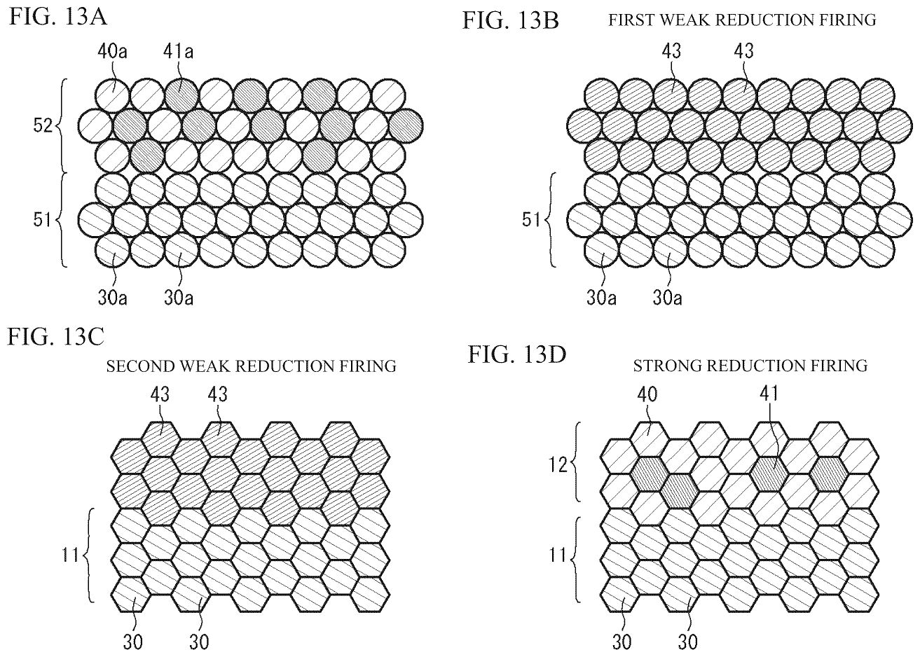

Next, the firing process is performed. FIG. 13A to FIG. 13D are diagrams illustrating the firing process. As illustrated in FIG. 13A, before firing, the internal electrode pattern 52 contains a nickel powder 40a and a magnesium oxide powder 41a. The ceramic green sheet 51 contains a dielectric powder 30a.

(First weak reduction firing process) Next, the multilayer body is subjected to the first weak reduction firing process. As illustrated in FIG. 13B, in this first weak reduction firing process, the nickel powder 40a and the magnesium oxide powder 41a are reacted in a weakly reducing atmosphere to produce Ni—Mg—O composite oxide grains 43. For example, firing is performed at a first temperature (for example, a temperature in the range of 1120° C. to 1180° C.) and a first oxygen partial pressure (for example, 1×10⁻⁹ atm to 5×10⁻⁹ atm) for a time period of 0.5 to 1.5 hours.

(Second weak reduction firing process) Next, following the first weak reduction firing process, the multilayer body is subjected to a second weak reduction firing process. As illustrated in FIG. 13C, this second weak reduction firing process sinters the composite oxide grains 43 and the dielectric powder 30a. The dielectric layer 11 is formed by sintering the dielectric powder 30a. For example, firing is performed at a second temperature higher than the first temperature (for example, a temperature in the range of 1210° C. to 1240° C.), at a second oxygen partial pressure (for example, an oxygen partial pressure in the range of 5×10⁻¹⁰ atm to 1×10⁻⁸ atm), and for a time of 0.5 to 1.5 hours.

There is little difference between the sintering start temperature of the Ni—Mg—O composite oxide grains 43 and the sintering start temperature of the dielectric powder 30a. Because the Ni—Mg—O composite oxide does not have the fluidity of high-temperature metals, discontinuities and peeling at the interface are suppressed, resulting in a sintered body integrated with the dielectric layer. Such a composite oxide sintered body forms an oxide film with a continuity modulus of nearly 100%, resulting in a ceramic thin film with suppressed discontinuities even after sintering, even when the thickness is 0.8 μm or less. However, in this state, the composite oxide sintered body is an insulator and therefore does not function well as a capacitor.

(Strong reduction firing process) After completing the second weak reduction sintering process, the multilayer body is cooled to room temperature and removed from the furnace. Next, the strong reduction sintering process is performed on the multilayer body that underwent the second weak reduction sintering process. As illustrated in FIG. 13D, in this strong reduction firing step, at least some of the composite oxide grains 43 are reduced to generate the nickel grains 40, thereby forming the internal electrode layers 12. For example, firing is performed at a temperature of a third temperature (lower than the second temperature, for example, a temperature in the range of 1180° C. to 1200° C.), at an oxygen partial pressure of a third oxygen partial pressure (lower than the first oxygen partial pressure and the second oxygen partial pressure, for example, an oxygen partial pressure in the range of 4×10⁻¹² atm or more and 1×10⁻¹¹ atm or less), for a time of 1.0 hour to 3.0 hours.

In the strong reduction firing process, since the sintering of the dielectric layer 11 is already complete and the temperature is lower than that of the second weak reduction firing process, nickel is reduced to metal within the internal electrode layer 12 by separating magnesium and oxygen while maintaining the properties of the Ni—Mg—O composite oxide. In this way, even if the sintered thickness is 0.8 μm or less, the internal electrode layer 12 with a continuity modulus of 90% or more can be formed. The composite oxide grains 43 may remain as composite oxide grains or may become magnesium oxide or the like, and become the magnesium oxide grains 41 described in FIG. 7 and FIG. 8.

After this strong reduction firing process, a characteristic structure is formed in which some of the magnesium separated from the nickel remains inside the internal electrode layer 12, as described in FIG. 7 and FIG. 8. In the strong reduction firing process, a reduction reaction occurs from the surface side of the internal electrode layer 12 (the interface side with the dielectric layer 11). Therefore, a high magnesium concentration is present in the center portion of the internal electrode layer 12 in the thickness direction.

After the strong reduction firing process, the sintered body is cooled to room temperature, and removed from the furnace. Because the internal electrode layers 12 are conductive, the sintered body functions as a capacitor. However, in this state, the sintered body may not be reliable enough to be used as a multilayer ceramic capacitor. This is because, during the process of reducing the complex oxide in the strong reduction firing process, the ceramic material that constitutes the dielectric layer 11 may also be weakly reduced, resulting in the generation of oxide-ion vacancies. The movement of these oxide-ion vacancies under DC voltage can cause insulation degradation in multilayer ceramic capacitors.

In multilayer ceramic capacitors in which nickel internal electrode layers and dielectric layers are co-fired, the composition is adjusted to a level that prevents semiconductor formation even when fired at high temperatures in a reducing atmosphere where nickel does not oxidize. Therefore, the dielectric layer 11 will not become a semiconductor in a reducing atmosphere in the strong reduction firing process. However, the increase in oxide-ion vacancies itself may not be preventable in principle.

(Re-oxidation process) It is therefore preferable to perform a re-oxidation process after the strong reduction firing step, which oxidizes only the dielectric. This is preferably performed at a lower temperature than the strong reduction firing step to prevent re-oxidation of the nickel. However, this can be a delicate heat treatment, requiring sufficient heat, oxygen, and time to allow oxide ions to diffuse and fill vacancies. As a result of the inventor's extensive research, it has been discovered that, for example, by performing heat treatment at a temperature between 800° C. and 950° C., an oxygen partial pressure between 5×10⁻⁷ atm and 1×10⁻⁵ atm, and a time between 0.5 and 1.5 hours, the dielectric layer 11 can be re-oxidized to a level that maintains both insulation and reliability under DC voltage while maintaining the reduced nickel in a metallic state.

The fact that “Ni—Mg—O oxide coexists with the nickel internal electrode layer” does not necessarily have to be achieved by the manufacturing method of this embodiment; it has also been reported, for example, in multilayer ceramic capacitors such as those illustrated in FIG. 7 of Japanese Patent Application Publication No. 2011-139028. However, this feature of the nickel internal electrode layer containing magnesium oxide is merely that “oxidation of nickel closer to the periphery simply proceeds due to oxygen coming from the outside, and if magnesium is present nearby at that time, Mg is taken up into NiO.” Also, because Ni—Mg—O is insulating, it is counted as a break in the nickel internal electrode layer, which is different from a structure in which the continuity modulus is maintained at 90% or more.

(Plating process) Then, a metal coating of Cu, Ni, Sn, or the like is applied to the base layers of the external electrodes 20a and 20b by plating. Through these steps, the multilayer ceramic capacitor 100 is completed.

Incidentally, since the sintering start temperature of the Ni—Mg—O composite oxide grains 43 is in the temperature range of 1150° C. to 1250° C., it is preferable that the dielectric layer 11 be adjusted to sinter within this temperature range. For example, if the dielectric layer 11 is primarily composed of barium titanate, the dielectric layer 11 preferably contains 0.5 mol % or more of silicon oxide (for example, SiO₂) with respect to 100 mol % barium titanate.

Furthermore, in the strong reduction firing process described above, the more quickly the magnesium separated from the composite oxide grains 43 can diffuse toward the dielectric layer 11, the faster the strong reduction firing process can proceed. Therefore, it is preferable that the magnesium concentration of the dielectric layer 11 be set low. In this embodiment, in the ceramic green sheet 51 before firing, with respect to 100 mol % of the ceramic components, the magnesium concentration is preferably 0.8 mol % or less, more preferably 0.5 mol % or less, and even more preferably 0.1 mol % or less. In the dielectric layer 11 after firing, when the main component ceramic is taken as 100 mol %, the magnesium concentration is preferably 1.5 mol % or less, more preferably 1.2 mol % or less, and even more preferably 0.6 mol % or less.

Furthermore, the thinner the dielectric layer 11, the greater the impact of the mismatch between the sintering of the nickel powder and the sintering of the ceramic green sheets, making the internal electrode layer 12 more susceptible to discontinuities. However, in this embodiment, even when the thickness of the dielectric layer 11 is 0.8 μm or less or 0.5 μm or less, it is possible to maintain a continuity modulus of 90% for the internal electrode layer 12.

Furthermore, if discontinuities occur in the internal electrode layer, causing distortion such as spheroidization, the greater the number of layers, the greater the cumulative amount of distortion, making cracks more likely to occur. However, according to this embodiment, because the internal electrode layer 12 has a continuity modulus of 90% or more, cracks are less likely to occur in the multilayer ceramic capacitor 100 even if the dielectric layer 11 and the internal electrode layer 12 each contain 100 or more layers. For example, in a multilayer ceramic capacitor having a size of 3216 or larger (length 3.2 mm, width 1.6 mm, height 1.6 mm), cracks are less likely to occur in the multilayer ceramic capacitor 100 even if the internal electrode layer 12 contains 1000 or more layers.

Furthermore, if the amount of magnesium oxide in the conductive paste contained in the internal electrode pattern 52 is too small, there will be portions of the entire internal electrode pattern 52 that do not become Ni—Mg—O composite oxide, which may result in a decrease in continuity in these portions. Therefore, it is preferable to set a lower limit on the amount of magnesium oxide in the conductive paste contained in the internal electrode pattern 52. On the other hand, if the amount of magnesium oxide in the conductive paste contained in the internal electrode pattern 52 is too high, a higher temperature and a more strongly reducing atmosphere will be required when reducing nickel in the strong reduction firing process, which may reduce the dielectric layer and generate a large number of oxide ion vacancies, resulting in reduced reliability. Therefore, it is preferable to set an upper limit on the amount of magnesium oxide in the conductive paste contained in the internal electrode pattern 52. In this embodiment, it is preferable that the conductive paste contained in the internal electrode pattern 52 contains 10 wt % or more and 30 wt % or less magnesium oxide powder, assuming that the nickel powder is 100 wt %.

Furthermore, in order to ensure that the nickel powder and magnesium oxide powder in the metal conductive paste contained in the internal electrode pattern 52 are well dispersed and mixed, it is preferable that the average particle size of the nickel powder be 150 nm or less, and that the average particle size of the magnesium oxide powder be 100 nm or less.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### EXAMPLES

(Examples 1 to 3, Reference Examples 1 to 2, and Comparative Examples 1 to 5) BaTiO₃ with an average particle size of 100 nm, prepared by solid-phase synthesis, was weighed out to a concentration of 100 mol %, with 1.5 mol % CaCO₃, 0.5 mol % MnCO₃, 1.5 mol % BaCO₃, 0.5 mol % Ho₂O₃ (1.0 mol % Ho), 0.5 mol % MgO, and 0.5 mol % B₂O₃ (1.0 mol % B). This mixed powder was dispersed with zirconia beads along with ethanol, toluene, and a dispersant. Dispersion was stopped when the median diameter of the BaTiO₃ particle size distribution reached 100 nm. After this dispersion, the slurry was separated from the zirconia beads by passing it through a filter. A PVB (polyvinyl butyral) resin binder was then added to produce a dielectric slurry. Using the slurry prepared in this way, a ceramic green sheet was coated onto a PET film using a die coater.

After drying the ceramic green sheet, a nickel paste was printed as an internal electrode pattern. The nickel paste used in Examples 1 to 3 and Reference Examples 1 to 2 consisted of 100 wt % nickel powder with an average particle size of 150 nm and 20 wt % MgO powder with an average particle size of 50 nm. In Comparative Examples 1 to 5, the nickel paste used consisted of 100 wt % nickel powder with an average particle size of 150 nm and 10 wt % BaTiO₃ powder as a co-material. The nickel paste thicknesses varied from the thinnest possible to the thickest possible within the paste viscosity range. Reference Example 1 used the thickest nickel paste, followed by Reference Example 2, Examples 1, 2, and 3, in that order. Similarly, in Comparative Example 1, the nickel paste was printed most thickly, and in Comparative Examples 2, 3, 4, and 5, the nickel paste was printed thinner in that order.

These printed sheets were stacked 101 times. The positive and negative electrode patterns were alternately stacked. Ceramic green sheets of the same composition, each 50 μm thick, were stacked on top and bottom of the printed sheets as cover sheets and pressed thermally. The resulting plate-like multilayer body was sintered and then cut into individual pieces (chips) measuring 1.0 mm×0.5 mm. The resulting chips were heated to 800° C. at a rate of 100° C./h in a reducing atmosphere using a N₂—H₂—H₂O mixed gas to remove the binder. The resulting chips were then processed using the process described in FIG. 10 and FIG. 13D to obtain multilayer ceramic capacitor samples. The first weak reduction firing process involved a temperature of 1150° C., an oxygen partial pressure of 1×10⁻⁹ to 5×10⁻⁹ atm, and a firing time of 1 hour. In the second weak reduction firing process, the temperature was 1220° C., the oxygen partial pressure was 5×10⁻¹⁰ to 1×10⁻⁸ atm, and the firing time was 1 hour. In the strong reduction firing process, the temperature was 1200° C., the oxygen partial pressure was 4×10⁻¹² to 1×10⁻¹¹ atm, and the firing time was 2 hours. For all samples, the total number of effective dielectric layers after sintering was 100, and the average dielectric thickness per layer was 0.5 μm.

The thickness of one internal electrode layer for the obtained samples was 1.2 μm for Reference Example 1, 0.9 μm for Reference Example 2, 0.6 μm for Example 1, 0.3 μm for Example 2, 0.1 μm for Example 3, 1.2 μm for Comparative Example 1, 0.9 μm for Comparative Example 2, 0.6 μm for Comparative Example 3, 0.3 μm for Comparative Example 4, and 0.1 μm for Comparative Example 5. Here, the thickness of one internal electrode layer is the average thickness of all effective dielectric layers.

The continuity modulus of the internal electrode layers was examined for the obtained samples. The continuity modulus of the internal electrode layers was 99% for Reference Example 1, 98% for Reference Example 2, 98% for Example 1, 95% for Example 2, 93% for Example 3, 98% for Comparative Example 1, 96% for Comparative Example 2, 87% for Comparative Example 3, 55% for Comparative Example 4, and 38% for Comparative Example 5. The average continuity modulus for 20 layers was used.

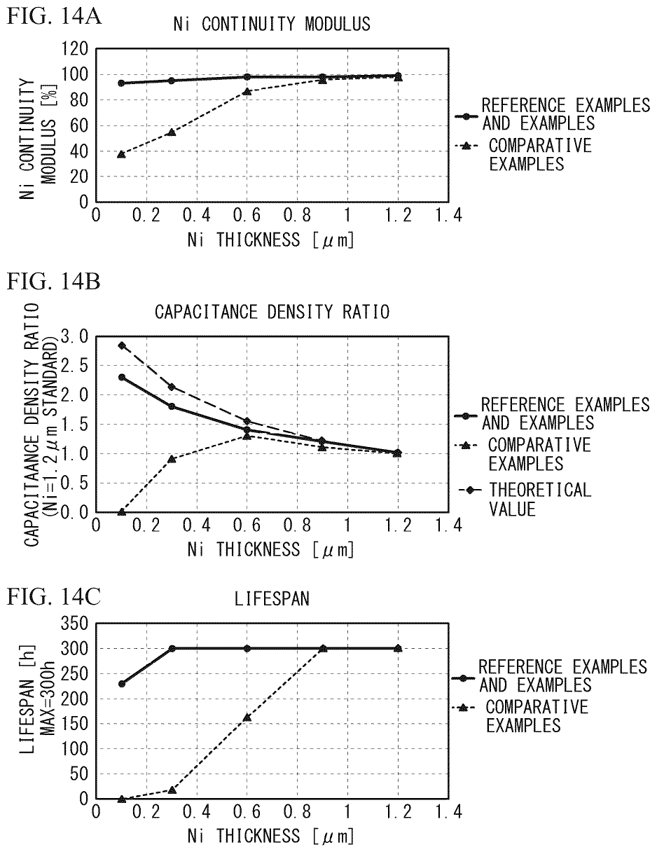

At the thickest internal electrode layer of 1.2 μm, the continuity modulus was approximately 100% for both Reference Example 1 and Comparative Example 1. The capacitance at this point was used as the reference capacitance, and the rate of increase in capacitance density as the thickness of the internal electrode layer was reduced is shown in Table 1 and FIG. 14A to FIG. 14C as the capacitance density ratio. The theoretical capacitance density value was calculated as follows. First, the thickness of the dielectric layer was fixed at 0.5 μm, and the number of dielectric layers was fixed at 100. In this case, the sum of the thicknesses of each dielectric layer and each internal electrode layer is the total thickness of the capacity section. Because the planar area of the internal electrode layers is fixed to a constant value through printing, a reduction in the total thickness of this capacity section means a corresponding reduction in the volume of the capacity section (the product of the planar area of the internal electrode layers and the total thickness of the capacitance-producing section). In this case, the capacitance remains constant because the material, thickness, and number of layers of the dielectric layers remain unchanged regardless of the thickness of the internal electrode layers. Therefore, a reduction in the total thickness of the capacity section means an increase in capacitance density (capacity divided by volume), and the ratio of the total thicknesses of the capacity sections is inversely proportional to the ratio of capacitance density. Here, the theoretical value is the rate at which the capacitance density increases inversely proportional to the rate at which the total thickness of the capacity section decreases while maintaining a constant capacitance, based on the capacitance density at a 1.2 μm internal electrode layer thickness. Therefore, if the actual value falls below this theoretical value, it indicates a significant reduction in the effective electrode area due to the discontinuity of the internal electrode layers.

Theoretically, even if the internal electrode layers become thinner, the capacitance remains unchanged because the thickness and number of dielectric layers remain constant. However, the capacitance density increases by the amount corresponding to the reduction in the volume of the capacitor equivalent to 100 layers. Therefore, Table 1 and FIG. 14B compare the theoretical and actual capacitance density increase rates. In Comparative Examples 1 to 5, as the internal electrode layers became thinner, the continuity modulus rapidly decreased, the deviation from the theoretical capacitance density increase rate increased, and reliability also decreased. In contrast, in Reference Examples 1 to 2 and Examples 1 to 3, the continuity modulus remained high and stable, the deviation from the theoretical capacitance density was small, and the decrease in reliability was also small. This difference was particularly clear when the internal electrode layer thickness was 0.3 μm or less. Here, reliability was evaluated by applying 12 V at 125° C. and monitoring the insulation resistance value for up to 300 hours. Failure was defined as a decrease in resistance to 1/100 of the resistance at the start of voltage application, and the time until that value was reached was defined as the lifespan.

TABLE 1

| | | CAPACITANCE | | | |
|---|---|---|---|---|---|
| | INTERNAL | DENSITY | | | |
| | ELECTRODE | RATIO | CAPACITANCE | CONTINUITY | AVERAGE |
| | THICKNESS | (THEORETICAL | DENSITY | MODULUS | LIFESPAN |
| | (μm) | VALUE) | RATIO | (%) | (h) |
| REFERENCE | 1.2 | 1.0 | 1.0 | 99 | 300 |
| EXAMPLE 1 | | | | | |
| REFERENCE | 0.9 | 1.2 | 1.2 | 98 | 300 |
| EXAMPLE 2 | | | | | |
| EXAMPLE 1 | 0.6 | 1.5 | 1.4 | 98 | 300 |
| EXAMPLE 2 | 0.3 | 2.1 | 1.8 | 95 | 300 |
| EXAMPLE 3 | 0.1 | 2.8 | 2.3 | 93 | 230 |
| COMPARATIVE | 1.2 | 1.0 | 1.0 | 98 | 300 |
| EXAMPLE 1 | | | | | |
| COMPARATIVE | 0.9 | 1.2 | 1.1 | 96 | 300 |
| EXAMPLE 2 | | | | | |
| COMPARATIVE | 0.6 | 1.5 | 1.3 | 87 | 163 |
| EXAMPLE 3 | | | | | |
| COMPARATIVE | 0.3 | 2.1 | 0.9 | 55 | 19 |
| EXAMPLE 4 | | | | | |
| COMPARATIVE | 0.1 | 2.8 | 0.0 | 38 | 0.0 |
| EXAMPLE 5 | | | | | |

These results demonstrate the surprising fact that, for internal electrode layers with thicknesses of 0.8 μm or less, a continuity modulus of 90% or greater can be achieved, enabling the internal electrode layers to be thinned without compromising reliability. This is presumably due to the inclusion of magnesium oxide within the nickel-based internal electrode layers.

(Reference Example 3, Example 4, and Comparative Examples 6 to 7) Samples for Reference Example 3 and Example 4 were prepared using the same procedures as Reference Examples 1 to 2 and Examples 1 to 3. The thickness of the internal electrode layers for the resulting samples was 1.0 μm for Reference Example 3 and 0.3 μm for Example 4. The continuity modulus of the internal electrode layers for the resulting samples was measured, and was found to be 98% for Reference Example 3 and 95% for Example 4.

Samples for Comparative Examples 6 to 7 were prepared using the same procedures as Comparative Examples 1 to 5. The thickness of the internal electrode layers for the resulting samples was 1.0 μm for Comparative Example 6 and 0.3 μm for Comparative Example 7. The continuity modulus of the internal electrode layers for the resulting samples was measured, and was found to be 96% for Comparative Example 6 and 55% for Comparative Example 7.

The failure rates of the samples for Reference Example 3, Example 4, and Comparative Examples 6 to 7 in a substrate bending test were measured. The results are shown in Table 2. In Reference Example 3 and Example 4, no failures occurred regardless of the thickness of the internal electrode layer, but in Comparative Examples 6 and 7, the failure rate was high, and it can be seen that the thinner the internal electrode layer, the higher the failure rate. From these results, it can be seen that the rigidity of the internal electrode layer can be increased by leaving magnesium in the internal electrode layer, which is mainly composed of nickel.

TABLE 2

| | INTERNAL | | FAILURE |
|---|---|---|---|
| | ELECTRODE | CONTINUITY | RATE OF |
| | THICKNESS | MODULUS | SUBSTRATE |
| | (μm) | (%) | BENDING TEST |
| REFERENCE | 1.0 | 98 | 0% |
| EXAMPLE 2 | | | |
| EXAMPLE 4 | 0.3 | 95 | 0% |
| COMPARATIVE | 1.0 | 96 | 67% |
| EXAMPLE 6 | | | |
| COMPARATIVE | 0.3 | 55 | 92% |
| EXAMPLE 7 | | | |

(Examples 5 to 9 and Comparative Examples 8 to 12) Samples for Examples 5 to 9 were prepared using the same procedures as Reference Examples 1 to 2 and Examples 1 to 3. The thickness of each of the internal electrode layers for the resulting samples was 0.3 μm in all of Examples 5 to 9. The thickness of each of the dielectric layers for the resulting samples was 2.0 μm in Example 5, 1.0 μm in Example 6, 0.8 μm in Example 7, 0.5 μm in Example 8, and 0.3 μm in Example 9. Here, the thickness of each of the internal electrode layer is the average thickness of all effective dielectric layers. The continuity modulus of the internal electrode layers was measured and found to be 98% in Example 5, 98% in Example 6, 95% in Example 7, 95% in Example 8, and 94% in Example 9.

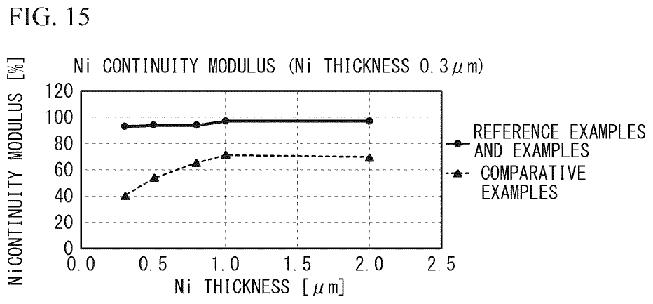

Samples for Comparative Examples 8 to 12 were prepared using the same procedures as Comparative Examples 1 to 5. The thickness of each of the internal electrode layers for the obtained samples was 0.3 μm in all of Comparative Examples 8 to 12. The thickness of each of the dielectric layers for the obtained samples was 2.0 μm in Comparative Example 8, 1.0 μm in Comparative Example 9, 0.8 μm in Comparative Example 10, 0.5 μm in Comparative Example 11, and 0.3 μm in Comparative Example 12. The continuity modulus of the internal electrode layers was 71% in Comparative Example 8, 72% in Comparative Example 9, 66% in Comparative Example 10, 55% in Comparative Example 11, and 41% in Comparative Example 12. The results are shown in Table 3 and FIG. 15.

TABLE 3

| | INTERNAL | DIELECTRIC | |
|---|---|---|---|
| | ELECTRODE | LAYER | CONTINUITY |
| | THICKNESS | THICKNESS | MODULUS |
| | (μm) | (μm) | (%) |
| EXAMPLE 5 | 0.3 | 2.0 | 98 |
| EXAMPLE 6 | | 1.0 | 98 |
| EXAMPLE 7 | | 0.8 | 95 |
| EXAMPLE 8 | | 0.5 | 95 |
| EXAMPLE 9 | | 0.3 | 94 |
| COMPARATIVE | 0.3 | 2.0 | 71 |
| EXAMPLE 8 | | | |
| COMPARATIVE | | 1.0 | 72 |
| EXAMPLE 9 | | | |
| COMPARATIVE | | 0.8 | 66 |
| EXAMPLE 10 | | | |
| COMPARATIVE | | 0.5 | 55 |
| EXAMPLE 11 | | | |
| COMPARATIVE | | 0.3 | 41 |
| EXAMPLE 12 | | | |

As shown in Table 3 and FIG. 15, when the dielectric layer thickness was thin enough to be 0.8 μm or less, it was not possible to maintain the continuity modulus of 90% or higher by reducing the internal electrode layer thickness to 0.3 μm or less in Comparative Examples 8 to 12. In contrast, in Examples 5 to 9, even with a dielectric layer thickness of 0.8 μm or less, it was possible to maintain the continuity modulus of 90% or higher with an internal electrode layer thickness of 0.3 μm or less.

(Examples 10 to 12 and Comparative Examples 13 to 15) Samples for Examples 10 to 12 were prepared using the same procedures as Reference Examples 1 to 2 and Examples 1 to 3. The number of internal electrode layers was 100 in Example 10, 500 in Example 11, and 1000 in Example 12. The thickness of each of the internal electrode layers in the obtained samples was 0.3 μm in all Examples 10 to 12. The continuity modulus of the internal electrode layers was 95% in Example 10, 96% in Example 11, and 95% in Example 12.

Samples for Comparative Examples 13 to 15 were prepared using the same procedures as Comparative Examples 1 to 5. The number of stacked internal electrode layers was 100 in Comparative Example 12, 500 in Comparative Example 14, and 1000 in Comparative Example 15. The thickness of each of the internal electrode layers for the resulting samples was 0.3 μm in all Comparative Examples 13 to 15. The continuity modulus of the internal electrode layers was 55% in Comparative Example 13, 49% in Comparative Example 14, and 42% in Comparative Example 15. The results are shown in Table 4. A 3216 shape was used in all Examples 10 to 12 and Comparative Examples 13 to 15.

TABLE 4

| | INTERNAL | | | CRACK |
|---|---|---|---|---|
| | ELECTRODE | CONTINUITY | NUMBER OF | OCCURRENCE |
| | THICKNESS | MODULUS | STACKED | RATE |
| | (μm) | (%) | LAYERS | (%) |
| EXAMPLE 10 | 0.3 | 95 | 100 | 0 |
| EXAMPLE 11 | | 96 | 500 | 0 |
| EXAMPLE 12 | | 95 | 1000 | 0 |
| COMPARATIVE | 0.3 | 55 | 100 | 22 |
| EXAMPLE 13 | | | | |
| COMPARATIVE | | 49 | 500 | 96 |
| EXAMPLE 14 | | | | |
| COMPARATIVE | | 42 | 1000 | 100 |
| EXAMPLE 15 | | | | |

As shown in Table 4, cracks were observed in Comparative Examples 13 to 15 even when the number of layers was 100. In contrast, cracks were not observed in Examples 10 to 12 even when the number of layers was 1000.

Although the embodiments of the present invention have been described in detail, it is to be understood that the various changes, substitutions, and alterations could be made hereto without departing from the spirit and scope of the invention.

What is claimed is:

1. A multilayer ceramic electronic device comprising:
a plurality of internal electrode layers facing each other, containing nickel as a main component, containing magnesium oxide inside thereof, having a thickness of 0.8 μm or less and a continuity modulus of 90% or more;
a dielectric layer sandwiched by the plurality of internal electrode layers; and
external electrodes electrically connected to the plurality of internal electrode layers respectively.

2. The multilayer ceramic electronic device as claimed in claim 1,
wherein the magnesium oxide is enclosed in each of the plurality of internal electrode layers.

3. The multilayer ceramic electronic device as claimed in claim 1,
wherein the magnesium oxide is a crystal represented by MgO or Ni—Mg—O.

4. The multilayer ceramic electronic device as claimed in claim 1,
wherein a nickel-magnesium alloy is enclosed in each of the plurality of internal electrode layers.

5. The multilayer ceramic electronic device as claimed in claim 1,
wherein a main component of the dielectric layer is barium titanate, and
wherein the dielectric layer contains 0.5 mol % or more of silicon oxide when an amount of the barium titanate is 100 mol %.

6. The multilayer ceramic electronic device as claimed in claim 1,
wherein the dielectric layer contains 1.5 mol % or less of magnesium when an amount of a main component ceramic of the dielectric layer is 100 mol %.

7. The multilayer ceramic electronic device as claimed in claim 1,
wherein a thickness of each of the plurality of internal electrode layers is 0.5 μm or less.

8. The multilayer ceramic electronic device as claimed in claim 1,
wherein a thickness of each of the plurality of internal electrode layers is 0.3 μm or less.

9. The multilayer ceramic electronic device as claimed in claim 1,
wherein each of the plurality of internal electrode layers and the dielectric layer has 100 or more layers.

10. A manufacturing method as a multilayer ceramic electronic device comprising:
forming each of internal electrode patterns on each of ceramic green sheets using conductive paste containing magnesium and nickel;
forming a multilayer body by stacking the ceramic green sheets;
firing the multilayer body under a first oxygen partial pressure and a first temperature to form a Ni—Mg—O composite oxide in each of the internal electrode patterns;
firing the multilayer body under a second oxygen partial pressure and a second temperature higher than the first temperature, and forming the ceramic green sheets into dielectric layers;
firing the multilayer body under a third oxygen partial pressure lower than the first oxygen partial pressure and the second oxygen partial pressure and a third temperature lower than the second temperature, and forming internal electrode layers containing magnesium therein from the internal electrode patterns; and
forming an external electrode on the multilayer body.

11. The method as claimed in claim 10,
wherein each of the ceramic green sheets contains 0.8 mol % or less of magnesium when a main component ceramic of the ceramic green sheets is 100 mol %.

12. The method as claimed in claim 10,
wherein the conductive paste contains 10 wt % or more and 30 wt % or less of magnesium when an amount of nickel is 100 wt %.
